(19) United States
(12) Patent Application Publication
(10) Pub. No.: US 2024/0265410 A1
(43) Pub. Date: Aug. 8, 2024

(54) METHOD FOR ANALYZING PUBLIC SATISFACTION, STORAGE MEDIUM AND ELECTRONIC DEVICE

(71) Applicant: Shanghai Midu Science and Technology Co., LTD., Shanghai (CN)

(72) Inventors: Jing JI, Shanghai (CN); Yidong LIU, Shanghai (CN); Jun WANG, Shanghai (CN)

(73) Assignee: Shanghai Midu Science and Technology Co., LTD., Shanghai (CN)

(21) Appl. No.: 18/574,066

(22) PCT Filed: Jul. 22, 2022
(86) PCT No.: PCT/CN2022/107244

§ 371 Date: Dec. 25, 2023

(30) Foreign Application Priority Data
Nov. 10, 2021 (CN) 202111323562.6

(51) Int. Cl. G06Q 30/0201

(52) U.S. Cl. CPC G06Q 30/0201

(57) ABSTRACT

A method for analyzing public satisfaction, a storage medium and an electronic device are provided; the method for analyzing public satisfaction including: collecting public feedback data; classifying the public feedback data into different categories; determining an attribute of public feedback data in each category based on sensitivity of the public feedback data in each category, wherein the attribute includes a positive attribute and a negative attribute; determining public satisfaction based on attributes of all categories of the public feedback data. The present disclosure takes into account both positive and negative information of data, as well as positive and negative information of events, and enables a deeper analysis of public satisfaction on the basis of public attention and the degree of dissemination.

### FIELD OF THE INVENTION

The present disclosure generally relates to the technical field of data analysis, in particular, to a method for analyzing public satisfaction, a storage medium and an electronic device.

### BACKGROUND OF THE INVENTION

Regarding public data generated through various channels, current technologies rely heavily on social media attributes such as likes and comments to analyze public attention or dissemination of certain event data. The data processing method is relatively simple. However, this kind of processing and analysis cannot reflect the trend formed by public attention, such as whether the public holds a positive or negative attitude.

Current analysis methods in this field, including attention calculation methods based on text features and direct calculation methods based on the original media data volume, are all techniques that can only obtain the public's attention to events. Taking the attention calculation methods based on text features as an example, keywords are extracted from source data and a focus index model is constructed; real-time network data is obtained, and an event attention index is calculated based on the focus index model to reflect the public's attention to events.

Therefore, how to provide a method for analyzing public satisfaction, a storage medium, and an electronic device to solve the defects that existing technologies cannot further analyze public satisfaction based on public attention and dissemination has become a technical problem that those skilled in the art urgently need to solve.

### SUMMARY OF THE INVENTION

The present disclosure provides a method for analyzing public satisfaction, a storage medium and an electronic device to solve the defects that existing technologies cannot further analyze public satisfaction based on public attention and dissemination.

One aspect of the present disclosure provides a method for analyzing public satisfaction, including: collecting public feedback data; classifying the public feedback data into different categories; determining an attribute of public feedback data in each category based on a sensitivity of the public feedback data in each category, wherein an attribute includes one or more of a positive attribute and a negative attribute; and determining public satisfaction based on attributes of all categories of the public feedback data.

In one embodiment of the present disclosure, collecting the public feedback data includes: setting a collection time period; and acquiring the public feedback data generated from all channels during the collection time period.

In one embodiment of the present disclosure, the categories of public feedback data include at least one of public opinion data, media data, and online reporting data.

In one embodiment of the present disclosure, determining the public satisfaction based on the attributes of all categories of the public feedback data includes: analyzing a sensitivity of the public opinion data and determining the public opinion data as positive data if the public opinion data is non-sensitive data, and determining the public opinion data as negative data if the public opinion data is sensitive data; performing event clustering on the media data to determine event information of the media data and data information of the media data; and performing event clustering on the online reporting data to determine event information of the online reporting data.

In one embodiment of the present disclosure, the event information of the media data includes a count of positive media events and a count of negative media events; the data information of the media data includes an amount of positive information of the positive media events and an amount of negative information of the negative media events; and the event information of the online reporting data is a count of negative events reported online.

In one embodiment of the present disclosure, determining the public satisfaction based on the attributes of all categories of the public feedback data includes: determining positive points or negative points of the public feedback data based on the attributes of all categories of the public feedback data; obtaining a distribution of negative emotion from the public feedback data; calculating a total positive point or a total negative point for the public feedback data of all categories based on the positive points of the public feedback data, the negative points of the public feedback data, and the distribution of negative emotion; determining a total satisfaction score by combining the total positive point and the total negative point; and correcting the total satisfaction score and determining the public satisfaction based on the corrected total satisfaction score.

In one embodiment of the present disclosure, the positive points include a positive point for public opinion, and/or a positive point for media; and the negative points include a negative point for public opinion, a negative point for media, and/or a negative point for online reporting.

In one embodiment of the present disclosure, correcting the total satisfaction score includes determining whether the total satisfaction score is greater than 0, if the total satisfaction score is greater than 0, correcting the total satisfaction score using a first function, if the total satisfaction score is not greater than 0, correcting the total satisfaction score using a second function.

Another aspect of the present disclosure provides a computer readable storage medium having a computer program stored thereon. The computer program when executed by a processor implements the method for analyzing public satisfaction.

Another aspect of the present disclosure provides an electronic device, including a processor and a memory. The memory is configured to store a computer program, and the processor is configured to execute the computer program stored in the memory to cause the electronic device to perform the method for analyzing public satisfaction.

As described above, the method for analyzing public satisfaction, the storage medium and the electronic device described in the present disclosure have the following beneficial effects:

The present disclosure classifies public feedback data into categories and determines positive or negative attributes of public feedback data for each category to analyze public satisfaction. In contrast to existing technologies, the present disclosure takes into account both positive and negative information of data, as well as positive and negative information of events, and enables a deeper analysis of public satisfaction on the basis of public attention and the degree of dissemination.

### BRIEF DESCRIPTION OF THE DRAWINGS

FIG. 1 is a schematic flow chart of a method for analyzing public satisfaction according to one embodiment of the present disclosure.

FIG. 2 is a data collection flow chart of a method for analyzing public satisfaction according to one embodiment of the present disclosure.

FIG. 3 is an attribute determination flow chart of a method for analyzing public satisfaction according to one embodiment of the present disclosure.

FIG. 4 is a public satisfaction analysis flowchart of a method for analyzing public satisfaction according to one embodiment of the present disclosure.

FIG. 5 is a block diagram of an electronic device according to one embodiment of the present disclosure.

### REFERENCE NUMERALS

1 Electronic device
11 Processor
12 Memory
S11 to S14 Various steps
S111 to S112 Various steps
S131 to S133 Various steps
S141 to S145 Various steps

### DETAILED DESCRIPTION

Embodiments of the present disclosure will be described below. Those skilled can easily understand disclosure advantages and effects of the present disclosure according to contents disclosed by the specification. The present disclosure can also be implemented or applied through other different exemplary embodiments. Various modifications or changes can also be made to all details in the specification based on different points of view and applications without departing from the spirit of the present disclosure. It should be noted that the following embodiments and the features of the following embodiments can be combined with each other if no conflict will result.

It should be noted that the drawings provided in this disclosure only illustrate the basic concept of the present disclosure in a schematic way, so the drawings only show the components closely related to the present disclosure. The drawings are not necessarily drawn according to the number, shape and size of the components in actual implementation; during the actual implementation, the type, quantity and proportion of each component can be changed as needed, and the components' layout may also be more complicated.

The method for analyzing public satisfaction, storage medium and electronic device of the present disclosure takes into account both positive and negative information of data, as well as positive and negative information of events, and enables a deeper analysis of public satisfaction on the basis of public attention and the degree of dissemination. The present disclosure is not about the satisfaction of a single event, but about the satisfaction of a certain type of event. For example, it can be about the satisfaction of the ecological environment of a city or region, or the satisfaction of public health and safety in a city or region. For example, if the public has a high level of attention to the Olympics during a certain period of time, the high level of attention obtained by existing technologies cannot reflect everyone's attitude towards the Olympics, that is, whether they are satisfied. The method for analyzing public satisfaction of the present disclosure can further analyze whether everyone is satisfied with the Olympics and what is their level of satisfaction.

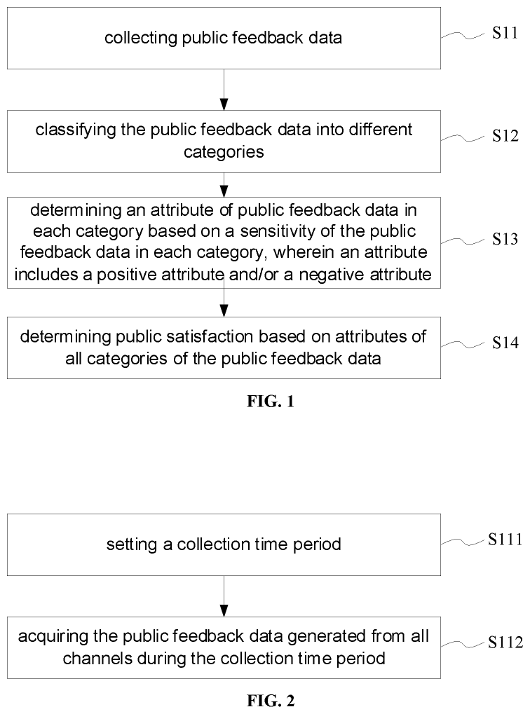

The principles and implementation of the method for analyzing public satisfaction, storage medium and electronic device of the present disclosure will be described in detail below in connection with FIGS. 1 to 5, so that a person skilled in the art can understand the method for analyzing public satisfaction, storage medium and electronic device of the present embodiment without creative labor.

Refer to FIG. 1, which is a schematic flow chart of the method for analyzing public satisfaction according to one embodiment of the present disclosure. As shown in FIG. 1, the method for analyzing public satisfaction specifically includes steps S11-S14 as described below.

S11, collecting public feedback data.

Refer to FIG. 2, which is a data collection flow chart of the method for analyzing public satisfaction according to one embodiment of the present disclosure.

As shown in FIG. 2, S11 includes steps S111 and S112. In one embodiment, the public feedback data is collected by a data-collecting module, which is a server or a general-purpose processor, including a central processing unit (CPU), and a network processor (NP). It can also be a Digital Signal Processing (DSP), Application Specific Integrated Circuit (ASIC), Field-Programmable Gate Array (Field-Programmable Gate Array, FPGA), other programming logic devices, discrete gates or transistor logic devices, or discrete hardware components.

S111, setting a collection time period.

Specifically, the collection time period is, for example, 1 hour; other reasonable time periods may also be applicable according to actual needs. The collection time period may be preconfigured by algorithms stored in the data-collecting module, or adjusted in real-time by operators through I/O ports of the data-collecting module.

S112, acquiring the public feedback data generated from all channels during the collection time period.

Specifically, within 1 hour, the public feedback data generated from all channels, i.e., public feedback data generated from public opinion channels, media channels, online reporting platforms, etc., are obtained. In practical applications, an entry of public feedback data is an entry of text data. In one embodiment, the public feedback data are generated by a variety of public-feedback servers, which may include servers of social media, severs of government websites, and severs of mainstream media; the public-feedback servers are communicated with the data-collecting module in a wired or wireless manner.

S12, classifying the public feedback data into different categories.

In an embodiment, the categories of public feedback data include at least one of: public opinion data, media data, and online reporting data. The public feedback data may be classified by a data-processing module, which is a server or a general-purpose processor, including a central processing unit (CPU), and a network processor (NP). It can also be a Digital Signal Processing (DSP), Application Specific Integrated Circuit (ASIC), Field-Programmable Gate Array (Field-Programmable Gate Array, FPGA), other programming logic devices, discrete gates or transistor logic devices, or discrete hardware components.

Specifically, the classification can be based on how the data is collected. In practical application, the classification can be based the source of the data collected. For example, if the data collected originates from a governmental reporting platform, the data falls into the category of online reporting data; if the collected data originates from official media platforms, the data falls into the category of media data; the public opinion data can be obtained by screening data from all Internet platforms based on keywords.

S13, determining an attribute of public feedback data in each category based on a sensitivity of the public feedback data in each category, wherein the attribute includes a positive attribute and/or a negative attribute (i.e., one or more of a positive attribute and a negative attribute).

Specifically, the positive and negative attributes can be determined by a Bidirectional Long Short-Term Memory (BiLSTM) model or other models that can implement dichotomous classification. The BiLSTM model used in the present disclosure is generated by training using a large amount of positive data and negative data. In one embodiment, the BiLSTM model runs on a server or a general-purpose processor, including a central processing unit (CPU), and a network processor (NP). It can also be a Digital Signal Processing (DSP), Application Specific Integrated Circuit (ASIC), Field-Programmable Gate Array (Field-Programmable Gate Array, FPGA), other programming logic devices, discrete gates or transistor logic devices, or discrete hardware components. In one embodiment, the BiLSTM model runs on the data-processing module.

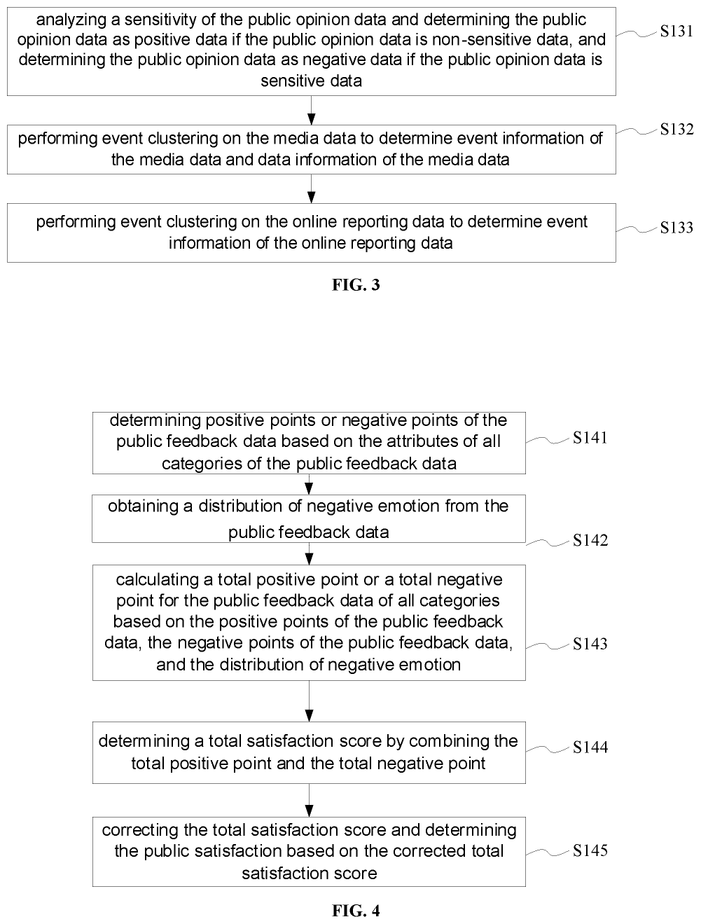

Refer to FIG. 3, which is an attribute determination flow chart of the method for analyzing public satisfaction according to one embodiment of the present disclosure. As shown in FIG. 3, S13 includes steps S131-S133.

S131, analyzing a sensitivity of the public opinion data and determining the public opinion data as positive data if the public opinion data is non-sensitive data, and determining the public opinion data as negative data if the public opinion data is sensitive data.

Specifically, the public opinion data is classified based on sensitivity: non-sensitive public opinion data is classified as positive public opinion data, and sensitive public opinion data is classified as negative public opinion data. The number of entries of positive public opinion data is considered as the amount of positive public opinion, and the number of entries of negative opinion data is considered as the amount of negative public opinion.

Further, the public opinion data is also classified based on emotion to obtain a percentage of negative information.

Specifically, the emotion classification may adopt an emotion classification model; for example, a multi-classification Bert model is used to perform multi-classification of joy, anger, sadness, fear, shock, and neutral. Assuming that there are a total of N entries of data, after the emotion classification, the following 4 negative emotions are obtained: a entries of public opinion data showing anger, b entries of public opinion data showing sadness, c entries of public opinion data showing fear, and d entries of public opinion data showing shock. Then the percentage of negative information=(a+b+c+d)/N.

S132, performing event clustering on the media data to determine event information of the media data and data information of the media data.

In an embodiment, the event information of the media data includes a count of positive media events and a count of negative media events; the data information of the media data includes an amount of positive information of the positive media events and an amount of negative information of the negative media events.

Specifically, event clustering is performed on the media data to determine positive media events (e.g., positive media reports) and negative media events (e.g., negative media reports), and the number of positive media events and the number of negative media events are counted respectively. The sensitivity classification is performed on each entry of media data; and according to the amount of sensitive information within each entry of media data, the entry of media data is classified as positive media data or negative media data, and the number of entries of positive media data is considered as the amount of positive information of the positive media events, and the number of entries of negative media data is considered as the amount of negative information of the negative media events.

In practice, for example, there are 100 entries of media data, after event clustering, the number of positive media events is determined to be 1, and the number of negative media events is determined to be 1; after sensitivity classification on each entry of media data, the number of entries of positive media data is determined to be 60 and the number of entries of negative media data is determined to be 40, in which case, the amount of positive information of the positive media events is 60 and the amount of negative information of the negative media events is 40.

Specifically, all the online reporting data are considered to be negative information, and the count of negative events reported online is obtained by event clustering.

S133, performing event clustering on the online reporting data to determine event information of the online reporting data.

In an embodiment, the event information of the online reporting data is a count of negative events reported online.

Specifically, for the clustering of the media data and the online reporting data, the principle is as follows: segment the text of each entry of media data or online reporting data, and take the average to obtain sentence vectors of sentences using a word2vec model. Calculate the similarity of sentence vectors for all texts, and cluster texts with high similarity as one type of event. Word2vec is a group of related models used to generate word vectors. These models are shallow and double-layered, used to train to reconstruct linguistic texts.

S14, determining public satisfaction based on attributes of all categories of the public feedback data.

Refer to FIG. 4, which is a public satisfaction analysis flowchart of the method for analyzing public satisfaction according to one embodiment of the present disclosure. As shown in FIG. 4, S14 includes steps S141-S145.

S141, determining positive points or negative points of the public feedback data based on the attributes of all categories of the public feedback data.

In an embodiment, the positive points include a positive point for public opinion, and/or a positive point for media; the negative points include a negative point for public opinion, a negative point for media, and/or a negative point for online reporting.

Specifically, according to the collated data, by independently logarithmizing the amounts of information IA and the counts of events EC, or logarithmizing IA\hat{ }EC, the positive and negative points of various types of data are obtained. These include: a negative point for public opinion, a positive point for public opinion, a negative point for media, a positive point for media, and a negative point for online reporting. In particular, a positive point for online reporting is set to 0. In one embodiment, this step is performed by hardware modules including a logarithmic operation circuit, or realized in the form of software called by processing components.

The function used for the logarithmization is: s=ln(a), where a denotes an amount of information IA, a count of events EC, or IA\hat{ }EC, and s denotes a positive or negative point.

S142, obtaining a distribution of negative emotion from the public feedback data.

Specifically, the distribution of negative emotion=the percentage of negative information *f. f denotes a scaling factor, used to ensure that the distribution of negative emotion has a value of the same order of magnitude as other scores. For example, if the positive point for public opinion ranges from 0-0.1 and the percentage of negative information is 0-0.01, then let f=10 and the distribution of negative emotion will be between 0-0.1. In one embodiment, this step is performed by hardware modules including a multiplier, or realized in the form of software called by processing components.

S143, calculating a total positive point or a total negative point for the public feedback data of all categories based on the positive points of the public feedback data, the negative points of the public feedback data, and the distribution of negative emotion.

Specifically, the total positive point is a weighted sum of all positive points and the total negative point is a weighted sum of all negative points.

Total negative point=a*negative point for public opinion+b*distribution of negative emotion+c*negative point for media+d*negative point for online reporting;

Total positive point=o*positive point for public opinion+p*(1−distribution of negative emotion)+q*positive point for media+r*positive point for online reporting.

a+b+c+d=1, and o+p+q+r=1.

In one example, a, b, c and d are 0.15, 0.25, 0.40 and 0.20 respectively, and o, p, q and rare 0.15, 0.25, 0.40 and 0.20 respectively. In practical applications, the weights can be adjusted according to business needs and/or different focuses. In one embodiment, this step is performed by hardware modules including multipliers and adders, or realized in the form of software called by processing components.

S144, determining a total satisfaction score by combining the total positive point and the total negative point.

Specifically, the total satisfaction score=the total positive points—the total negative points.

S145, correcting the total satisfaction score and determining the public satisfaction based on the corrected total satisfaction score.

In an embodiment, correcting the total satisfaction score includes: determining whether the total satisfaction score is greater than 0, if the total satisfaction score is greater than 0, correcting the total satisfaction score using a first function, and if the total satisfaction score is not greater than 0, correcting the total satisfaction score using a second function.

Specifically, the total satisfaction score is corrected using the Sigmoid function with predetermined threshold. The Sigmoid function is a common S-shaped function, also known as an S-shaped growth curve. In information science, the Sigmoid function is often used as an activation function in neural networks due to its monotonicity and monotonicity of its inverse function, mapping variables to 0˜1. In one embodiment, this step is performed by a programmable digital sigmoid function generator circuit.

In practical applications, when the total score is greater than 0, a first function is used for calculation:

$$\\ y = \frac{1}{1 + {i}^{{}_{} - ( x + j )}}$$

when the total score is less than or equal to 0, a second function is used for calculation:

$$\\ y = \frac{1}{1 + {m}^{{}_{} - ( x + n )}}$$

x represents the original total score, y represents the revised score, and l, j, m, n are formula constants. The formula constants are not of fixed values, but are obtained according to different event types. That is, different event types have different values for the formula constants. In the actual setting process, a certain event direction is first selected, and according to the data and results of different cities, it is repeatedly adjusted according to the feedback from the business side.

In practical applications, mainly the variables i, j, m, n in the Sigmoid function are adjusted to achieve a total satisfaction score that is more consistent with human subjective perception. In one embodiment, the variables are adjusted according to inputs from the public-feedback servers. For example, if there is a major health and safety incident in a city, then if the current concern is satisfaction with the health and safety aspects of the city, then satisfaction will decline during this time. Again, for example, for certain aspects there are, for example, mainstream media rankings that will serve as a basis for comparison between cities.

In a specific adjustment process of i, j, m, n, for example, after obtaining a city's data for one month, the business side will feedback to us whether the overall score is too high or too low or whether it is sensitive to different inputs. i and m can help control sensitivity to input and j and n can help control the overall score level.

It should be noted that characteristics of the Sigmoid function include: (1) it is monotonically increasing. (2) Its function value ranges from 0 to 1. (3) It is compatible with both positive and negative inputs. (4) The change becomes slower when the input becomes larger or smaller. In addition, other suitable functions with the above characteristics (1)-(4) can also be used for the correction.

Further, public feedback data can be divided into different regions before being analyzed and processed, and public satisfaction analysis can be carried out for different regions, and then the analysis results of different regions can be quantitatively displayed and clearly presented for comparison, and the analysis results of different regions can be compared with each other to analyze the differences in public satisfaction for the same type of event (such as ecological environment or public health safety) in different regions. Specifically, if the collection time period is set to 1 hour, then for cities A and B, a y-value will be generated every 1 hour. As a result, multiple y-values for cities A and B can be presented to users in the form of statistical charts, Excel tables, etc., showing the changes in public satisfaction in city A or city B over time, as well as the differences in public satisfaction between city A and city B during the same time period, and any public satisfaction information that can be directly or indirectly obtained through y-values.

In embodiments of the present disclosure, the analysis of public satisfaction can be performed solely based on positive and negative attributes of data, or based on positive and negative attributes of events after event clustering, or the analysis can be performed by combining the positive and negative attributes of the data and events. The combined analysis is preferred, but standalone analysis methods can also be used.

In traditional index calculation methods, direct scaling and weighted calculations are performed on raw data, while the method for analyzing public satisfaction of the present disclosure first classifies data/events by sensitivity, then considers positive and negative points, resulting in a more accurate public satisfaction. The present disclosure uses a variant Sigmoid function adjusted according to a specific threshold to correct scores, making score calculation more flexible and changeable, since the function's parameters can be adjusted according to a large amount of real-world data to obtain a score that is more consistent with human subjective perception.

The scope of protection of the method for analyzing public satisfaction described in the present disclosure is not limited to the sequence of operations listed herein. Any scheme realized by adding or subtracting operations or replacing operations of the traditional techniques according to the principle of the present disclosure is included in the scope of protection of the present disclosure.

The present disclosure also provides a non-transitory computer-readable storage medium on which a computer program is stored. When executed by a processor, the computer program implements the method for analyzing public satisfaction.

It may be appreciated by those of ordinary skill in the art that all or some of the steps that implement the method embodiments described above may be accomplished by hardware related to computer programs. The aforementioned computer program may be stored in a computer readable storage medium. Operations of the aforementioned methods are performed when the program is executed; and the aforementioned computer readable storage media includes an ROM, an RAM, a magnetic disk, an optical disk, or any of other various media that can store software programs.

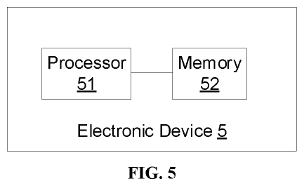

FIG. 5 is a block diagram of an electronic device according to one embodiment of the present disclosure. As shown in FIG. 5, the present disclosure provides an electronic device 5, including: a processor 51 and a memory 52; the memory 52 is used to store a computer program, and the processor 51 is used to execute the computer program stored in the memory 52 to cause the electronic device 5 to perform the various steps of the method for analyzing public satisfaction.

The processor 51 may be a general-purpose processor, for example, a central processing unit (CPU), a network processor (NP), etc.; it may also be a Digital Signal Processor (DSP), Application Specific Integrated Circuit (ASIC), Field-Programmable Gate Array (FPGA), other programming logic devices, discrete gates or transistor logic devices, or discrete hardware components.

The memory 52 may include Random Access Memory (RAM), or may also include non-volatile memory, such as at least one disk memory.

In practical applications, the electronic device can be a computer including components such as a memory, a storage controller, one or more processing units (CPUs), peripheral interfaces, RF circuits, audio circuits, speakers, microphones, input/output (I/O) subsystems, displays, other output or control devices, and external ports. The computer includes but is not limited to personal computers such as desktop computers, laptops, tablets, smartphones, smart TVs, personal digital assistants (PDAs), etc. In other embodiments, the electronic device can also be a server. The server can be deployed on one or more physical servers based on various factors such as function and load. It can also be a cloud server composed of distributed or centralized server clusters.

In summary, the method for analyzing public satisfaction, storage medium, and electronic device of the present disclosure classify public feedback data into categories and determines positive or negative attributes of public feedback data for each category to analyze public satisfaction. In contrast to existing technologies, the present disclosure takes into account both positive and negative information of data, as well as positive and negative information of events, and enables a deeper analysis of public satisfaction on the basis of public attention and the degree of dissemination. Therefore, the present disclosure effectively overcomes various shortcomings of the prior art and has a high industrial value.

The above-mentioned embodiments are just used for exemplarily describing the principle and effects of the present disclosure instead of restricting the present disclosure. Those skilled in the art can make modifications or changes to the above-mentioned embodiments without going against the spirit and the range of the present disclosure. Therefore, all equivalent modifications or changes made by those who have common knowledge in the art without departing from the spirit and technical concept disclosed by the present disclosure shall be still covered by the claims of the present disclosure.

1. A method for analyzing public satisfaction, including:
collecting public feedback data;
classifying the public feedback data into different categories, wherein the categories of the public feedback data include at least one of public opinion data, media data, and online reporting data;
analyzing a sensitivity of the public opinion data and determining the public opinion data as positive data if the public opinion data is non-sensitive data, and determining the public opinion data as negative data if the public opinion data is sensitive data; performing event clustering on the media data to determine event information of the media data and data information of the media data; and performing event clustering on the online reporting data to determine event information of the online reporting data; and
determining at least one of positive points of the public feedback data, negative points of the public feedback data, and a distribution of negative emotion in each category based on data information and event information in each category of the public feedback data; determining a total satisfaction score based on at least one of the positive points of the public feedback data, the negative points of the public feedback data, and the distribution of negative emotion; and determining public satisfaction based on the total satisfaction score.

2. The method for analyzing public satisfaction according to claim 1, wherein the collecting of the public feedback data includes:
setting a collection time period; and
acquiring the public feedback data generated from all channels during the collection time period.

3. (canceled)

4. (canceled)

5. The method for analyzing public satisfaction according to claim 1, wherein
the event information of the media data includes a count of positive media events and a count of negative media events;
the data information of the media data includes an amount of positive information of the positive media events and an amount of negative information of the negative media events; and
the event information of the online reporting data is a count of negative events reported online.

6. The method for analyzing public satisfaction according to claim 1, wherein determining at least one of positive points of the public feedback data, negative points of the public feedback data, and a distribution of negative emotion in each category based on the data information and the event information in each category of the public feedback data; determining a total satisfaction score based on at least one of the positive points of the public feedback data, the negative points of the public feedback data, and the distribution of negative emotion includes:
determining positive points or negative points of the public feedback data based on the data information and the event information in each category of the public feedback data;
determining the distribution of negative emotion from the public feedback data;
calculating a total positive point or a total negative point for the public feedback data of all categories based on the positive points of the public feedback data, the negative points of the public feedback data, and the distribution of negative emotion;
determining the total satisfaction score by combining the total positive point and the total negative point; and
correcting the total satisfaction score and determining the public satisfaction based on the corrected total satisfaction score.

7. The method for analyzing public satisfaction according to claim 6, wherein
the positive points include one or more of a positive point for public opinion and a positive point for media; and
the negative points include a negative point for public opinion, a negative point for media, and/or a negative point for online reporting.

8. The method for analyzing public satisfaction according to claim 6, wherein the correcting of the total satisfaction score includes:
determining whether the total satisfaction score is greater than 0, if the total satisfaction score is greater than 0, correcting the total satisfaction score using a first function, if the total satisfaction score is not greater than 0, correcting the total satisfaction score using a second function.

9. A non-transitory computer readable storage medium having a computer program stored thereon, wherein the computer program when executed by a processor implements a method for analyzing public satisfaction as described in claim 1.

10. An electronic device, including a processor and a memory,
wherein the memory is configured to store a computer program, and the processor is configured to execute the computer program stored in the memory to cause the electronic device to perform a method for analyzing public satisfaction as described in claim 1.
